(19) United States
(12) Patent Application Publication
(10) Pub. No.: US 2025/0313044 A1
(43) Pub. Date: Oct. 9, 2025

(54) METHOD, CONTROL UNIT AND SYSTEM FOR DETERMINING THE TREAD DEPTH OF A TIRE

(71) Applicants: Continental Reifen Deutschland GmbH, Hannover (DE); Continental Automotive Technologies GmbH, Hannover (DE)

(72) Inventors: Martin Kurz, Hannover (DE); Nicolas Guinart, Toulouse (FR); Parthiv Dharamshi, Regensburg (DE)

(73) Assignees: Continental Reifen Deutschland GmbH, Hannover (DE); Continental Automotive Technologies GmbH, Hannover (DE)

(21) Appl. No.: 18/864,716

(22) PCT Filed: Mar. 22, 2023
(86) PCT No.: PCT/EP2023/057372

§ 371 Date: Nov. 11, 2024

(30) Foreign Application Priority Data
May 13, 2022 (DE) 10 2022 204 695.1

(51) Int. Cl. B60C 11/24

(52) U.S. Cl. CPC B60C 11/246

(57) ABSTRACT

A method and control system for determining the tread depth of a tire tread, in which the current dynamic rolling radius of the tire is continually determined in usage phases of the tire by ascertaining a current angular velocity of the tire from data determined by a first sensor and ascertaining a current velocity of the vehicle from data determined by a second sensor and determining the current dynamic rolling radius on the basis of the determined current angular velocity and the current velocity of the vehicle. A starting value of the dynamic rolling radius is recorded at the beginning of a first usage phase and a current tread depth of the tire is determined from deviations of the current dynamic rolling radius from the starting value, and wherein a current movement status of the tire is ascertained from data determined by a third sensor, by determining a usage phase as the movement status if data determined above a predefined limit value exist and determining a non-usage phase as the movement status if data determined below a predefined limit value over a predefined time period exist. In the event of a change in the movement status from a non-usage phase to a subsequent usage phase, a new starting value of the dynamic rolling radius is recorded and the subsequently determined current dynamic rolling radii are compared with said new starting value instead of with the previous starting value in order to continually determine the current tread depth.

The invention relates to a method for determining the profile depth of a profile of a tire fitted on a wheel rim on a vehicle, in which method the current dynamic rolling radius of the tire is continually determined in phases of use, in that a current rotational speed of the tire is determined from data determined by a first sensor and a current speed of the vehicle is determined from data determined by a second sensor and the current dynamic rolling radius is determined on the basis of the determined current rotational speed of the tire and the current speed of the vehicle, a starting value of the dynamic rolling radius being recorded at the beginning of a first phase of use and a current profile depth of the tire being determined from deviations of the current dynamic rolling radius from the starting value. Furthermore, the invention also relates to a control device and to a system for a vehicle for determining the profile depth of a profile of a tire fitted on the vehicle.

In the area of determining the actual profile depth of a tire fitted on a vehicle, the so-called rolling-radius-based approach is a very promising method for estimating the current profile depth of a tire fitted on a vehicle without needing manual measurement on the tire. The basic principle of this method is based on the fact that the dynamic rolling radius of the tire, and consequently also the revolutions of the same over the distance covered, are subject to change if the current profile depth decreases as a result of tire wear. In this case, with a given tire inflation pressure and a given tire load, the dynamic rolling radius decreases, whereas the number of revolutions of the tire over the distance covered, and consequently also its speed, increase. By way of example, in this respect reference may be made to DE 10 2012 217 901 B3.

Using a GPS receiver in the vehicle, the vehicle speed is determined and, for example using wheel speed sensors, the current rotational speed of the tire is determined. From these values, the dynamic rolling radius is determined. From a comparison of a starting value of the dynamic rolling radius at the beginning of the first phase of use with the currently determined dynamic rolling radius, the current profile depth of the tire can be calculated from the decrease in the rolling radius over time, it being attempted by means of mathematical methods to keep the determined values stable and to eliminate inevitable disturbances and fluctuations in the data determined by the first and second sensors.

However, there is the problem that, when the tire is not in use for a lengthy period of time, i.e. in a phase of non-use, the last-calculated current value of the dynamic rolling radius is stored and then, when the tire is used once again, this value is used for the continued calculation or determination of the current profile depth. In particular in the case of tires which remain fitted on the wheel rims as complete wheel sets and, for example as a set of summer tires or winter tires, only have a phase of use of several months followed by a phase of non-use of several months, this gives rise to a problem, since the physical dimensions of the tire change as a result of unavoidable effects of creep or aging of the rubber material used or other parts of the tire. In particular if a tire is stored in a phase of non-use as a complete wheel while inflated to the intended tire pressure, such a tire has a tendency to increase in its diameter, whereby the dynamic rolling radius is also changed and the result of the determination of the current profile depth in a subsequent phase of use of the tire may be falsified.

The object of the invention is therefore to provide a method, a control device and a system for determining a profile depth of a profile of a tire which take the non-use or storage of the tire into account in the determination of the profile depth.

To achieve the set object, a method according to the features of patent claim 1 is proposed according to the invention.

Advantageous configurations and developments of the method according to the invention are the subject matter of the dependent claims.

A control device for achieving the set object is the subject matter of patent claim 9 and a system is the subject matter of patent claim 10.

According to the invention, it is provided that in addition a current movement status of the tire is determined from data determined by a third sensor, in that when there are data determined above a specified limit value a phase of use is determined as the movement status and when there are data determined below a specified limit value over a predetermined time period a phase of non-use is determined as the movement status, and when there is a change in the movement status from a phase of non-use to a subsequent phase of use the recording of a new starting value of the dynamic rolling radius is instigated and, instead of the previous starting value, is compared with the subsequently determined current dynamic rolling radii for the continued determination of the current profile depth.

In other words, determination of a phase of non-use over an appropriately fixed predetermined time period causes the generation of a movement status which on resumption of the phase of use first instigates the fixing of a new starting value of the dynamic rolling radius, which is exchanged for the starting value fixed in the previous phase of use and is compared as a comparison value with the determined current dynamic rolling radii and the resultant determination of the current profile depth. In this way, dimensional changes of the tire during its phases of non-use are automatically taken into account, since they are included in the newly determined starting value.

The dynamic rolling radius is understood here and hereinafter as meaning that rolling radius that a rigid wheel has in order to have the same rolling circumference at a specific speed as that which the actual tire has at this speed. The rolling circumference is in this case the distance which a tire covers in one revolution without any slip.

For determining the movement status of the tire, according to one proposal of the invention, an acceleration sensor is used as a third sensor, which delivers data concerning the radial or tangential acceleration of the tire or the corresponding change in the acceleration. A magnetic sensor may also be provided as the third sensor.

The limit value of the acceleration determined by the third sensor, which went present over a predetermined time period triggers the generation of a phase of non-use as a movement status, lies at a low acceleration value untypical for tire use on the vehicle or is equal to zero.

The predetermined time period after which the phase of non-use is generated as the movement status when the limit value is constantly not reached can be chosen as desired by a person skilled in the art, as long as it is set to such a level that it is suitable for example for indicating the change from summer tires to winter tires and the associated phase of non-use due to storage of the other set of tires respectively. For example, the time period may be fixed at at least 14 days, at least 30 days or the like.

The first sensor for determining the current rotational speed of the tire may be for example a rotational-speed sensor fitted on the vehicle, such as is used by customary assistance systems, for instance ABS or ESP systems. In this way, the rotational speed of the tire can be determined easily and reliably.

The determination of the current rotational speed of the tire in this case typically comprises a determination of a current angular speed of the tire.

According to one proposal of the invention, a sensor of a tire pressure monitoring system (TPMS) that is assigned to the tire is used as the third sensor for determining the current movement status of the tire. Such sensors are usually capable of measuring the tire pressure and the temperature and are typically also equipped with an acceleration sensor, in order to establish whether the tire or the complete wheel is being used and a signal is to be sent to a corresponding receiver in the vehicle. Such a signal transmission is usually only performed when the vehicle is in use, in order to limit energy consumption, although the sensors measure the pressure, the temperature and the acceleration even at a standstill, but do not transmit them to the receiver in the vehicle. Typically, such a TPMS sensor changes to a parking state if it determines a constant and low radial acceleration of less than 3 g for a minimum time period of for example 15 minutes. Then the pressure, the temperature and the acceleration are only measured periodically, for example every 16 seconds, an average value formed and this value stored. If therefore such a sensor establishes by several measurements over the predetermined time period that they are characteristic of lengthy storage, for example because of seasonal storage, this can be used to generate a phase of non-use as a movement status, which is transmitted to the receiving device in the vehicle as soon as the TPMS sensor establishes renewed use on the vehicle, i.e. a new current radial acceleration is determined, indicating a change from the phase of non-use to a subsequent renewed phase of use and causing a corresponding change in the movement status of the tire.

According to one proposal of the invention, determination of a phase of non-use of the tire causes the setting or generation of a corresponding signal value, which can be subsequently sent to the receiving device in the vehicle and indicates the change from a phase of non-use to a phase of use.

For example, as soon as it determines a new driving cycle or a new phase of use, i.e. a radial acceleration higher than the predefined limit value is established, the TPMS sensor can transmit the information generated during the storage, in particular the average pressure, temperature, acceleration and the signal value during the first minutes after the initialization of the new driving cycle periodically to the receiving device in the vehicle, for example for 10 minutes. The transmission of the signal value triggers the recording of a new starting value of the dynamic rolling radius which is used instead of the previous starting value and is compared with the subsequently determined current dynamic rolling radii for the continued determination of the current profile depth. Consequently, a new learning cycle is started after a resumed phase of use, in order to determine the new tire geometry and to set the parameters which are included in the calculation of the current profile depth of the tire. The signal value generated is then erased again. Instead of a set signal value, a measurement of the time period of the phase of non-use and the exceeding of the predetermined time period of for example 14 or 30 days could also be used as a basis for immediately instigating the recording of a new starting value and its use instead of the previous starting value.

In this way, during the phase of non-use of the tire, dimensional changes that have occurred over the predetermined time period are automatically taken into account in the subsequently continued determination of the current profile depth in the phase of use.

It goes without saying that the new recording of a starting value and the replacement of the previously used starting value by this newly recorded starting value can be repeated as often as desired in the course of the method according to the invention following a lengthy storage period which has led to generation of the movement status as a phase of non-use.

In a further configuration of the invention, the TPMS sensor may manage a counter for the lengthy storage phases, which is incrementally increased after each lengthy storage phase that passes. With this information it is possible to cover cases of rare use of the tire in which the tire concerned could be fitted on different vehicles over the course of time, with changing phases of use and phases of non-use, and thus possibly undergoes several lengthy phases of non-use without having the possibility of reporting the information to each vehicle.

Without such a counter for lengthy phases of non-use, a first vehicle would be informed about a phase of non-use whereas a second vehicle, which is subsequently equipped with this tire, would not be capable of detecting such an “earlier” phase of non-use.

Inclusion of a counter allows the vehicle concerned to decide to initiate the recording of a new starting value by comparing the current value of the counter for the phases of non-use reported by the TPMS sensor with the last value known to the vehicle concerned.

According to one proposal of the invention, the determination of the dynamic rolling radius relies on data of the current speed of a vehicle which are determined by a second sensor, which is selected from the group comprising a satellite-based sensor, i.e. a GPS sensor, a radar sensor, a lidar sensor, an ultrasound sensor and an optical camera, all of which make a precise determination of the actual vehicle speed over the ground possible. Any other sensor which delivers the speed independently of the rotational wheel speed is also suitable as a second sensor in the sense of the invention.

According to a further proposal of the invention, correction factors, which for example take into account the tire size, the tire pressure, the tire type, the temperature, the tire load and/or the tire age, may also be taken into account in the determination of the current profile depth to increase the accuracy.

In addition, according to a further proposal, determination of a phase of non-use may also cause the horizontal or vertical orientation of the tire during storage to be determined, in particular by way of the acceleration sensor included in the measurement, since this storage orientation has an influence on the change in the geometrical properties of the tire during non-use. It is for example known that, when a tire is stored vertically under load, flats can occur at the circumference of the tire and result in a reduction of the rolling circumference. This can then be taken into account in the course of the invention by corresponding correction factors.

The current profile depth of the tire determined in the way described above can for example be transmitted to the vehicle electronics of the vehicle, in order to calculate a corresponding service requirement and/or to be displayed in the vehicle, in order for example to inform the user of the vehicle about the reaching of the required minimum profile depth and a correspondingly imminent change of the tires. Moreover, the determined current profile depth may also be made available to corresponding driving-dynamics control systems of the vehicle, in order to influence their control parameters. The determined profile depth may also be transmitted in the course of a telemetry application to a remote control station of the vehicle, in order also to monitor the profile depth and the state of the tires from a distance, which is of advantage for example for fleet management, carsharing providers and the like.

The invention also relates to a control device for a vehicle for determining the profile depth of a profile of a tire fitted on the vehicle. The control device has at least one receiving device for receiving a current rotational speed of the tire and a current speed of the vehicle. Moreover, it has a determining device for determining a dynamic rolling radius of the tire on the basis of the determined current rotational speed of the tire and the current speed of the vehicle in comparison with a starting value that can be fixed, the receiving device being designed for receiving a movement status comprising phases of use and phases of non-use and, when there is a change in the movement status from a phase of non-use to a phase of use, the determining device being activatable by the receiving device in such a way that a new starting value of the dynamic rolling radius can be fixed and can be used instead of the previous starting value for determining the profile depth.

The control device may be designed as an independent control device for the vehicle or may be a component part of a further control device, for example a control device of the TPMS sensors of a tire pressure monitoring system, an anti-lock braking system and/or a driving-dynamics control system.

The invention also relates to a system for a vehicle for determining the profile depth of a profile of a tire fitted on a wheel rim on the vehicle. The system has a control device according to said embodiment, it being possible for the movement status to be generated by a sensor of a tire pressure monitoring system assigned to the tire.

An embodiment of the invention is explained in more detail below on the basis of the accompanying figures.

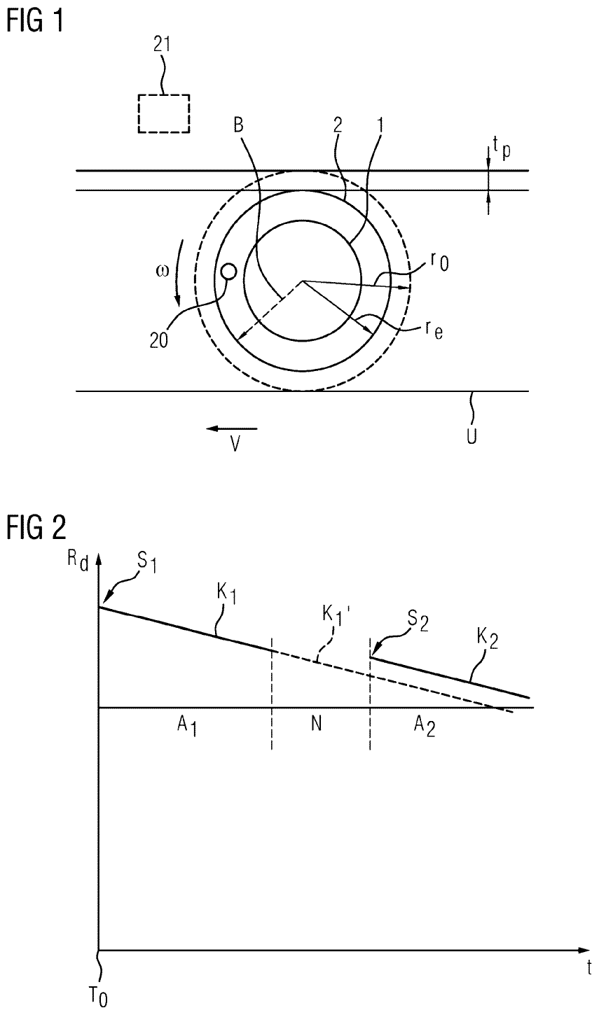

FIG. 1 shows a schematic side view of a tire fastened or fitted on a vehicle that is not shown here.

FIG. 2 shows a diagram in which the variation of the dynamic rolling radius of a tire over its period of use is recorded.

Shown in the schematic representation according to FIG. 1 is a tire 2, which is fitted on a wheel rim 1 and, together with it, is mounted as a complete wheel on a motor vehicle that is not represented here. The tire 2 rolls with its outer circumference on the underlying surface U, the original radius r₀ of the tire 2 being represented by dashed lines and the radius toward the end of the period of use being indicated by rₑ and depicted by solid lines. The difference between the original radius r₀ and the radius rₑ toward the end of the period of use represents the usable profile depth tₚ of the tire 2. The currently applicable profile depth tₚ is consequently a measure of whether the tire 2 can still be used, since it is still below its intended period of use, or else has been reduced to the minimum profile depth by reaching the radius rₑ toward the end of the period of use, so that a change of the tire 2 is required.

In order to determine the profile depth tₚ of the profile of the tire 2 during use of the vehicle without performing a manual measurement, the current rotational speed w of the tire 2 is determined in a way known per se, for example according to WO 2014053322 A1, by means of a first sensor in the vehicle (not represented here), for example by corresponding rotational-speed sensors of an ABS or ESP system.

In addition, the actual speed V of the vehicle, together with the tires 2 fitted on it, in the horizontal direction over the underlying surface U is determined by a second sensor in the vehicle, for example a GPS sensor 21 of the navigation system fitted in the vehicle. From these determined data for the current rotational speed ω of the tire 2 and the current speed V of the vehicle, the current dynamic rolling radius R_{d} is determined, according to the equation R_{d}=V/ω.

At the beginning of the period of use of the tire 2, a starting value S₁ of the dynamic rolling radius R_{d} is recorded, as it can be seen at the point in time T₀ from the graphic representation according to FIG. 2.

Subsequently, current rotational speeds w of the tire 2 and associated current speeds V of the vehicle are determined continuously or continually at fixed time intervals from the data determined by the first and second sensors 21, the associated dynamic rolling radius R_{d} is determined and compared with the starting value S₁. Since, owing to wear, the radius of the tire 2 decreases from the original radius r₀ in the direction of the radius rₑ, there is accordingly also a decrease in the dynamic current rolling radius R_{d}, which is directly proportional to the current profile depth tₚ, so that the latter can be determined from the observed deviation of the current dynamic rolling radius R_{d} from the starting value S₁.

It can be seen in FIG. 2 that, for example in the case of a summer tire, owing to wear, the dynamic rolling radius R_{d}, and correspondingly the current profile depth tₚ determined from it, decrease along a falling line K₁ over the first phase of use A₁. With completion of the first phase of use A₁, this tire 2 is changed for example for a winter tire and for the duration of the use of the winter tires is stored in a corresponding phase of non-use N, i.e. the radial acceleration B of the tire 2 has continuously the value “0”.

In order to be able to determine this standstill of the tire 2 even when it is stored while not fitted on the vehicle, a sensor 20 of a tire pressure monitoring system (TPMS sensor) that is fitted on the wheel rim 1 of the tire 2 is used, also determining in addition to the tire pressure and the tire temperature by means of a corresponding acceleration sensor the radial acceleration B acting on the tire 2, which can be used to derive a movement status of the tire 2, which is determined either as a phase of use A₁, A₂ or as a phase of non-use N.

A radial acceleration B, determined by the sensor 20, above a specified limit value has the effect that the movement status is determined as a phase of use A₁, A₂.

However, as soon as the determined radial acceleration B remains below a specified limit value over a predetermined time period of for example 30 days, the movement status is determined as a phase of non-use N and the sensor 20 generates a signal value, which is stored in addition to the periodically stored values for tire pressure and temperature in the sensor 20.

As soon as toward the end of the phase of non-use N a renewed change of the tires is imminent, and the currently stored tires 2 are put to use again, in the representation according to FIG. 2 over the phase of use A₂, the sensor 20 of the tire pressure monitoring system sends its measured values, stored during the phase of non-use N, and the generated signal value to a receiving device in the vehicle, the signal value sent along with the tire-pressure and temperature values having the effect that in the recommenced determination of the dynamic rolling radius R_{d} first a new starting value S₂ is determined and used instead of the previous starting value S₁ as a basis for the further measured-value analysis.

Following behavior typical of a tire 2 stored under inflation pressure, during the phase of non-use N it has undergone an increase in its radius due to the mechanical properties inherent in the tire material, so that a continuation of the comparison of the deviations of the current dynamic rolling radius R_{d} from the starting value S₁ along the imaginary line K₁′ continued from the line K₁ would lead to a falsification of the measurement result, since this radial increase of the tire 2 would remain unconsidered.

By fixing the new starting value S₂ at the beginning of the next phase of use A₂, following the phase of non-use N, the radial increase visible from the representation according to FIG. 2 as a vertical offset is taken into account and the subsequently determined current dynamic rolling radii Ra are compared along the line K₂ with the new starting value S₂, in order to be able to correctly reproduce the exact decrease in the profile depth tₚ in spite of the increased radius of the tire 2 in the phase of non-use N. The previously inevitable falsification of the measurement result in the consideration of the dynamic rolling radius R_{d} on a tire 2 that has been unused for a lengthy period of time, for example has been stored, is in this way compensated.

Typically, the profile depth tₚ is continuously determined during driving of the vehicle. In this case both an absolute value of the profile depth tₚ and a relative change in the profile depth tₚ with respect to a previously determined value may be determined.

The profile depth tₚ is in this case preferably determined for all of the tires 2 of the vehicle, i.e. the determination of the respective current rotational speed, the current dynamic rolling radius and any correction values is performed separately for each tire 2, and is set in relation to the current speed of the vehicle determined jointly for all of the tires 2.

The essential advantage of the previously described method and the control device and the system for a vehicle is that the quality of the determined profile depth estimation of the tire 2 is significantly improved over the so-called rolling-radius-based approach. Geometrical changes in the tires 2 that occur gradually during tire storage are included in the determination. This is of significance in particular in markets that have a high number of users who change the tires 2 on their vehicles seasonally.

### LIST OF REFERENCE SIGNS

1: Wheel rim
2: Tire
20: Third sensor
21: Second sensor
A₁: First phase of use
N: Phase of non-use
A₂: Second phase of use
B: Radial acceleration
V: Current speed
K₁: First line
K₁′: Imaginary continuation
K₂: Second line
ω: Current rotational speed
R_{d}: Dynamic rolling radius
r₀: Original radius
rₑ: Radius toward the end of the period of use
S₁: First starting value
S₂: New starting value
T₀: Point in time of the beginning of the period of use
tₚ: Profile depth
U: Underlying surface

1. A method for determining the profile depth of a profile of a tire fitted on a wheel rim on a vehicle, in which method the current dynamic rolling radius of the tire is continually determined in phases of use thereof, in that a current rotational speed of the tire is determined from data determined by a first sensor and a current speed of the vehicle is determined from data determined by a second sensor and the current dynamic rolling radius is determined on the basis of the determined current rotational speed and the current speed of the vehicle, a starting value of the dynamic rolling radius being recorded at the beginning of a first phase of use and a current profile depth of the tire being determined from deviations of the current dynamic rolling radius from the starting value, wherein a current movement status of the tire is determined from data determined by a third sensor, in that when there are data determined above a specified limit value a phase of use is determined as the movement status and when there are data determined below a specified limit value over a predetermined time period a phase of non-use is determined as the movement status, and when there is a change in the movement status from a phase of non-use to a subsequent phase of use the recording of a new starting value of the dynamic rolling radius is instigated and, instead of the previous starting value, is compared with the subsequently determined current dynamic rolling radii for the continued determination of the current profile depth.

2. The method as claimed in claim 1, wherein the third sensor determines the radial acceleration of the tire or the tangential acceleration of the tire or changes in the acceleration of the tire.

3. The method as claimed in claim 1, wherein the third sensor takes the form of a sensor of a tire pressure monitoring system that is assigned to the tire.

4. The method as claimed in claim 1, wherein a signal value is generated in the determination of a phase of non-use.

5. The method as claimed in claim 4, wherein a counter of which the value is incrementally increased each time a signal value is generated is provided for the signal value.

6. The method as claimed in claim 1, wherein the first sensor is designed as a rotational-speed sensor.

7. The method as claimed in claim 1, wherein the second sensor is selected from the group comprising a satellite-assisted sensor, a radar sensor, a lidar sensor, an ultrasound sensor and an optical camera.

8. The method as claimed in claim 1, wherein correction factors, comprising the tire size, the tire pressure, the tire type, the temperature, the tire load and/or the tire age, are taken into account in the determination of the current profile depth.

9. The method as claimed in claim 1, wherein determination of a phase of non-use of the tire also causes the horizontal or vertical orientation of the tire to be determined and to be used for forming a correction factor which is taken into account in the determination of the current profile depth.

10. A control device for a vehicle for determining the profile depth of a profile of a tire fitted on a wheel rim on a vehicle, comprising at least one receiving device for receiving a current rotational speed of the tire and a current speed of the vehicle, a determining device for determining a dynamic rolling radius of the tire on the basis of the current rotational speed of the tire and the current speed of the vehicle in comparison with a starting value that can be fixed for determining the profile depth, the receiving device being designed for receiving a movement status comprising phases of use and phases of non-use and, when there is a change in the movement status from a phase of non-use to a subsequent phase of use, the determining device being activatable by the receiving device in such a way that a new starting value of the dynamic rolling radius can be fixed and can be used instead of the starting value for determining the profile depth.

11. A system for a vehicle for determining the profile depth of a profile of a tire fitted on a wheel rim on a vehicle, having a control device as claimed in claim 10, it being possible for the movement status to be generated by a sensor of a tire pressure monitoring system assigned to the tire.
